(19) United States
(12) Patent Application Publication
(10) Pub. No.: US 2026/0259177 A1
(43) Pub. Date: Sep. 3, 2026

(54) METHOD AND SYSTEM FOR EVALUATING STRENGTH AND FATIQUE OF A FIBER REINFORCE STRUCTURE

(71) Applicant: FCA US LLC, Auburn Hills, MI (US)

(72) Inventors: Mingchao Guo, Auburn Hills, MI (US); Congyue Wang, Auburn Hills, MI (US)

(21) Appl. No.: 19/066,873

(22) Filed: Feb. 28, 2025

(51) Int. Cl. G01N 29/12

(52) U.S. Cl. CPC G01N 29/12; G01N 2291/014; G01N 2291/0231

(57) ABSTRACT

A method of determining stress and fatigue for a component includes determining a maximum distortion energy for a component formed of a fiber reinforced material, performing a strength evaluation by comparing the maximum distortion energy to a strength threshold, determining a fatigue evaluation by comparing the maximum distortion energy to a fatigue threshold and generating a report comprising the strength evaluation.

### FIELD

The present disclosure relates to anisotropic material used for vehicle structures, and, more specifically, to a method and system for evaluating the suitability of a vehicle structure using an anisotropic material.

### BACKGROUND

This section provides background information related to the present disclosure which is not necessarily prior art.

One approach of reducing vehicle weight is using composite materials, one general type is fiber reinforced composite material. An example of fiber reinforced composite material includes fiber reinforced polypropylene (FRPP), which is one of most popular composite materials. FRPP is a typical anisotropic material with material properties that are highly dependent on fiber orientations and environmental temperatures. The material also is brittle, and it fractures quickly if cracks develop under service loads. This makes strength and fatigue analyses of a structure made of this type of materials very complicated.

Detailed strength and fatigue analyses include manufacture simulation to obtain fiber orientations and material property calculations to generate the strength and fatigue properties with different fiber orientations and under different temporaries, as well as knit line, with fundamental test coupon results input. The typical process is too complicated, analysis time is consuming and not practical as a routine strength and fatigue evaluation procedure to support product design and development.

### SUMMARY

This section provides a general summary of the disclosure, and is not a comprehensive disclosure of its full scope or all of its features.

In one aspect of the disclosure, a method of determining stress and fatigue for a component includes determining a maximum distortion energy for a component formed of a fiber reinforced material, performing a strength evaluation by comparing the maximum distortion energy to a strength threshold, determining a fatigue evaluation by comparing the maximum distortion energy to a fatigue threshold and generating a report comprising the strength evaluation.

In another aspect of the disclosure, a system determining stress and fatigue for a component includes a processor and a non-transitory computer-readable medium including machine readable instructions that are executable by the processor. The machine readable instructions include instructions to determine a maximum distortion energy for a component formed of a fiber reinforced material, perform a strength evaluation by comparing the maximum distortion energy to a strength threshold, determine a fatigue evaluation by comparing the maximum distortion energy to a fatigue threshold and generate a report comprising the strength evaluation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic view of a portion of the vehicle including a battery tray.

FIG. 2 are three diagrams illustrating the X, Y and Z inertial load versus a number of times the load has been achieved in three orientations.

FIG. 3 is a perspective view of the battery tray as well as locations of accelerometers and temperature sensors used for twelve channels of data in the present method.

FIG. 4 is a block diagrammatic view of a system for performing the method of present disclosure.

FIG. 5 is a flowchart of a method for determining stress and fatigue for the battery tray of FIGS. 1 and 3.

Corresponding reference numerals indicate corresponding parts throughout the several views of the drawings.

### DETAILED DESCRIPTION

Example embodiments will now be described more fully with reference to the accompanying drawings.

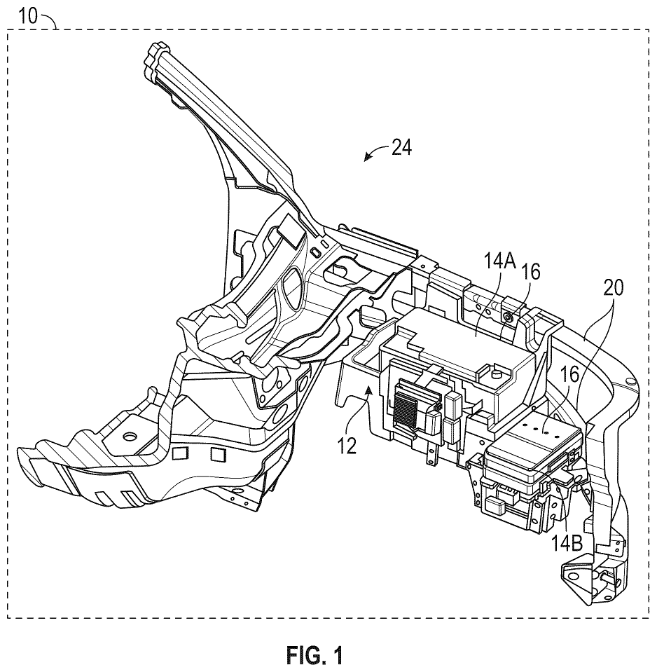

Referring now to FIG. 1, a representation of a vehicle 10 having a battery tray 12 disposed therein is set forth. The battery tray 12 is an example of a fiber reinforced component. The fiber reinforced component is a fiber reinforced polypropylene (FRPP). While a battery tray 12 is illustrated as the component in the present example, other types of fiber reinforced polypropylene components such as a washer bottle or other types of trays or supporting structure within a vehicle may be used. The present example uses polypropylene. However, other types of fiber reinforced materials may be used. The battery tray 12 may be used to support a first battery 14A and a second battery 14B. The batteries 14A, 14B are disposed within a housing 16 which, in turn, have cells (not shown) therein. The housings 16 are supported by the battery tray 12.

The battery tray 12 is supported within the vehicle by a support structure 20. The support structure 20 may be part of the frame or structure of the vehicle. However, the support structure may also be other types of cross members and components coupled to the vehicle.

As will be described in greater detail below, a non-linear stress analysis is used in the determination of strength and fatigue performance. A non-linear stress analysis center of gravity (CG) G-loads are applied as a set of accelerations to the structure 24 that includes the battery tray 12, the support structure 20 and the components illustrated in FIG. 1.

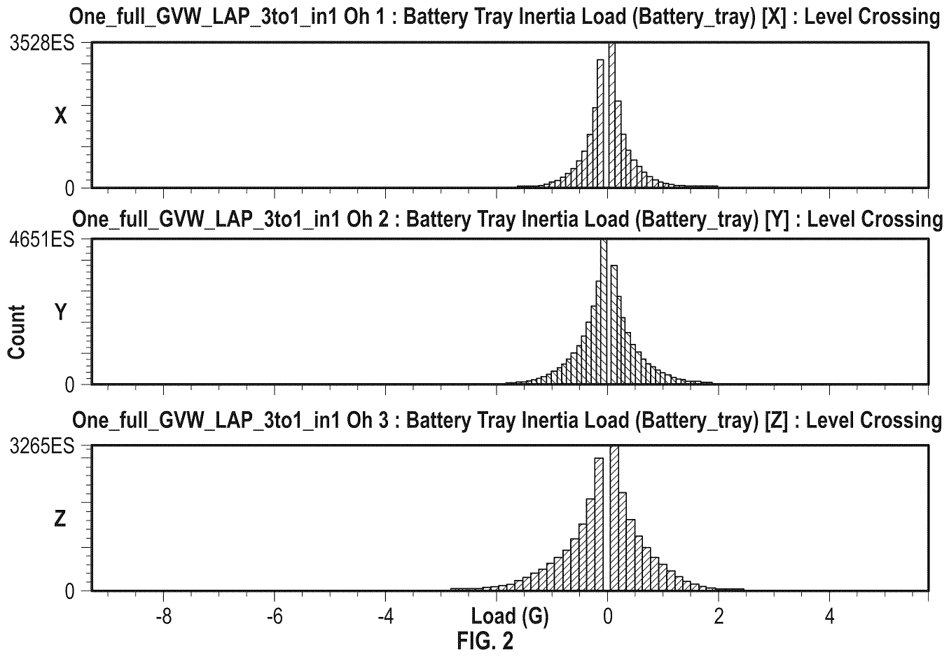

Referring now also to FIG. 2, the CG accelerations are accelerations that have a magnitudes in the X, Y and Z directions. The CG accelerations are determined based on a load level crossing which is a distribution of the acceleration magnitudes versus a count when the level is above various load levels. In FIG. 2, the accelerations in the X, Y and Z direction are counted for various loads along the X, Y and Z directions. The X axis of the graph corresponds to the load in units of gravity (Gs). The vertical axis corresponds to the count. The CG G loads are used to determine the strength level of the G loads and the fatigue level of the G loads. The strength level of the G loads is the maximum acceleration in the X, Y and Z directions both positive and negative. The fatigue level G loads are the highest acceleration with around 10,000 cycle repeats in X, Y and Z directions, respectively, both positive and negative. For both the strength level G loads and the fatigue level G loads, all three directions (X, Y and Z) are considered.

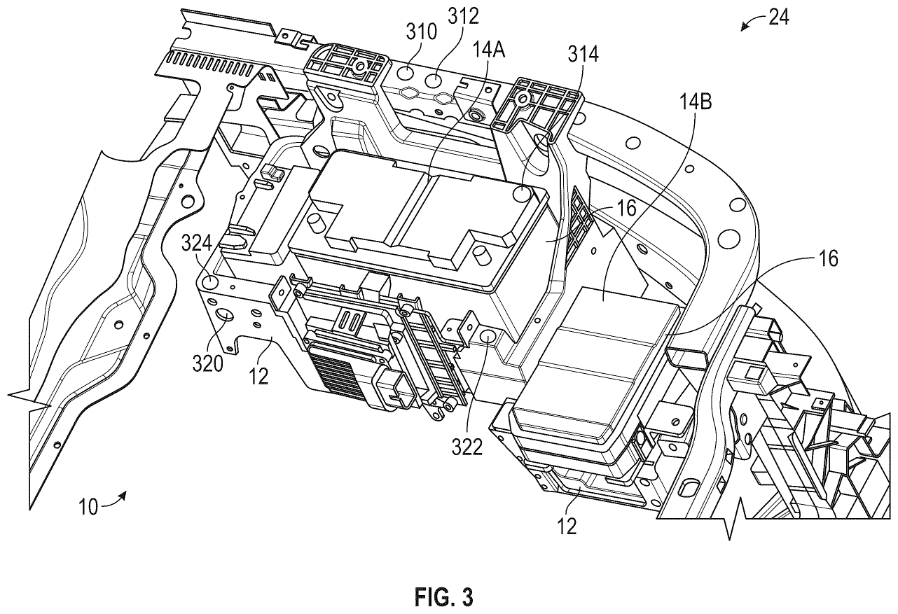

Referring now to FIG. 3, the components of FIG. 1 are illustrated and numbered the same. In this example, various accelerometers are placed on the structure 24. In this example, twelve channels are measured in various locations. For example, the accelerator 310 measures X, Y and Z direction accelerations. A temperature 312 measures the temperature sensor on the body of the vehicle. A battery tray accelerometer 314 measures battery accelerations in the X and Z directions. A temperature sensor 320 measure the temperature on the battery tray 12. An accelerometer 322 measures acceleration of the battery tray in the X, Y and Z directions. In total, ten channels are used for acceleration and two channels are used for temperature. The configuration illustrated in FIG. 3 is used in a proving ground vehicle data acquisition system. Ultimately, proving ground vehicle data acquisition is used or data may be acquired from vehicle level dynamic analysis using the proving ground time history load input.

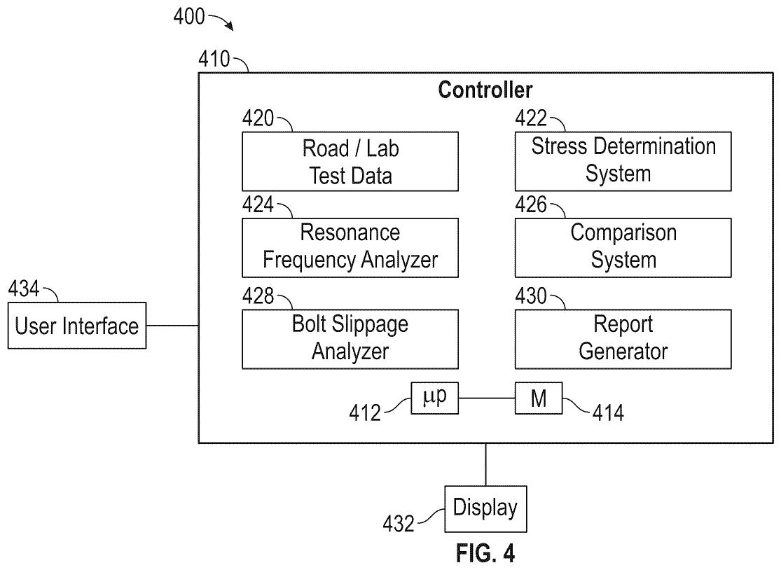

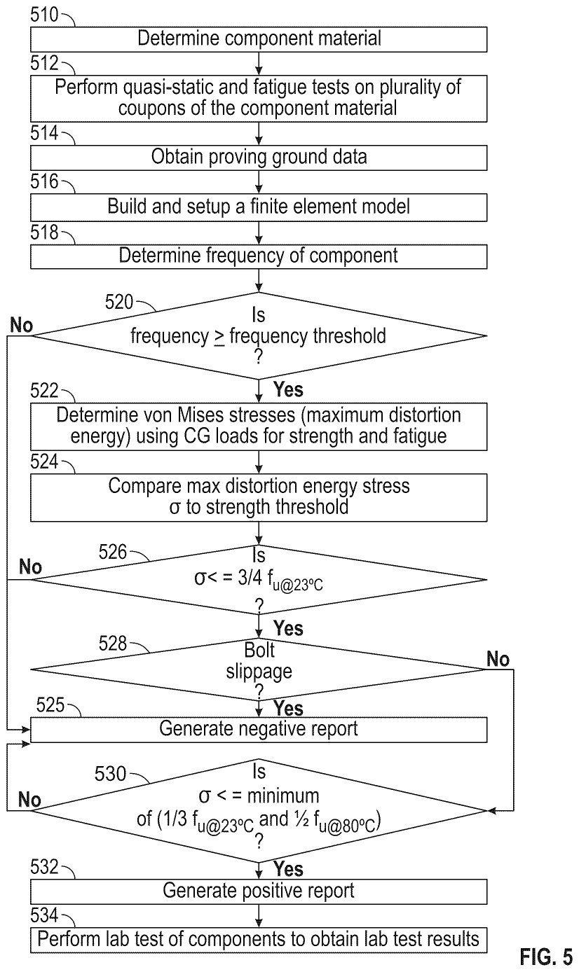

Referring now to FIG. 4, a system 400 for determining stress and fatigue is set forth. The system 400 has a controller 410 that has a microprocessor or processor 412 in a memory 414. The memory 414 is a non-transitory computer-readable medium that includes machine-readable instructions that are executable by the processor. The machine-readable instructions include instructions for performing the method set forth below in FIG. 5.

The controller 410 includes a road/lab test data block 420. The road/lab test data block 420 may use proving ground data as described above using the sensors illustrated in FIG. 3. However, the road data may be obtained then lab results performed based upon the road test data previously taken. That is, a computer model may be used to generate the data that was obtained from the configuration set forth in FIG. 3 rather than directly measuring the accelerations in the temperatures. Ultimately, a stress determination system 422 is used to obtain the von Mises stress from non-linear stress analysis using the center of gravity G-loads as described above. This process will be described in greater detail below.

The controller 410 also includes a resonance frequency analyzer 424. The resonance frequency analyzer 424 determines the resonance frequency of the structure such as the battery tray 12 illustrated above. The output of the resonance frequency analyzer and the stress determination system 422 may be coupled to a comparison system 426. The resonance frequency analyzer 424 is used to determine whether the resonance frequency of the structure component is greater than a resonance frequency threshold such as 20 Hz. The resonance frequency threshold is chosen so that above the threshold desirable results are obtains. The comparison system 426 may also compare the stress from the stress determination system to various thresholds. In the present example, a strength performance threshold and a fatigue performance threshold may be compared to the stress determined in the stress determination system.

A bolt slippage analyzer 428 may be used to determine whether any of the bolts that secure the components such as the battery tray to the structure of the vehicle is being manifested. When bolt slippage is determined, the part analyzer may fail.

Ultimately, a report generator 430 may be used to generate a report that includes data from the stress determination system 422, the resonance frequency analyzer 424, the comparison system 426, the bolt slippage analyzer 428 and the report generator 430. Ultimately, the report may be displayed on a display 432 that is coupled to the controller. An operator may control the controller 410 and the various functioning of the system with a user interface 434.

Referring now to FIG. 5, a method for performing fatigue and strength analysis is set forth. The material may be various types of fiber reinforced materials such as fiber reinforced polypropylene (FRPP). The fiber reinforced polypropylene is typically considered an isotropic material. However, in this example, an anisotropic material is treated as an isotropic material.

In step 512, a quasi-static and fatigue test are performed on a plurality of coupons of the component material.

In step 514, providing ground data may be obtained. The proving ground data may be used to obtained the accelerations in various directions such as that illustrated in FIG. 3. However, the proving ground data may be used for numerally obtaining data in a computer lab test that simulates the movement of the vehicle according to the directions experienced during the proving ground movement in step 516. In step 518, von Mises stresses are determined. The von Mises stress may be referred to as the maximum distortion energy. The von Mises stresses are determined using the center of gravity loads for strength and fatigue. The center of gravity loads were described above. In step 520, the maximum distortion energy stress is compared to a strength threshold. In step 522, when the stress is less than or equal to ¾ f_{u,23C}. at about room temperature of within a few degrees of 23 degrees C. That is, if the stress σ<=¾ f_{u,23}° the configuration passes the strength test. In step 522, when the system does not pass the strength test, a negative report may be generated in step 524. In step 522, when the system passes the strength test, bolt joint slippage may be determined. When the system does not pass bolt joint slippage, step 524 generates a negative report. In step 526, when the system does bolt slippage, meaning there is no bolt slippage, step 528 is performed. The bolt slippage is evaluated with a clamp joint analysis under the strength level G-loads.

In step 528 is compared to a fatigue threshold. The fatigue threshold may be two thresholds. The first threshold may be composite tensile strength in the injection molding flow/fiber orientation and under room condition which is specified in the material specification. This is set forth as ⅓ f_{u,23C} or comparing the material tensile strength in injection molding flow/fiber orientation and under 80° C. temperature condition which is specified in the material specification as ½ f_{u,80C}. That is, the minimum of σ<=minimum of ⅓ f_{u,23}°_{C} and ½ f_{u,80}°_{C} where fᵤ is the composite material tensile strength.

In step 528, the stress or von Mises strength is compared to the lower or minimum of about the room temperature or about 80° C. stress threshold. About means within 4 degrees Celsius. When the stress is greater than the minimum under room temperature or 80° C., the negative report is generated in step 524. In step 528, when the von Mises stress or maximum distortion energy is less than the lower one of the two thresholds, step 530 is performed. In step 530, the resonance frequency component is determined. In step 532, the resonance frequency is compared with a frequency threshold when the resonance frequency of the component is greater than the frequency threshold, a negative is generated in step 524. In step 532, if the resonance frequency is less than the frequency threshold, a positive report is generated in step 534.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
determining a maximum distortion energy for a component formed of a fiber reinforced material;
performing a strength evaluation by comparing the maximum distortion energy to a strength threshold;
determining a fatigue evaluation by comparing the maximum distortion energy to a fatigue threshold; and
generating a report comprising the strength evaluation.

2. The method of claim 1 wherein determining a maximum distortion energy comprises determining a von Mises stress.

3. The method of claim 1 wherein determining the maximum distortion energy comprises determining the maximum distortion energy using center of gravity G-loads.

4. The method of claim 1 wherein determining the maximum distortion energy comprises determining the maximum distortion energy using center of gravity G-loads using proving ground data.

5. The method of claim 1 wherein determining the maximum distortion energy comprises determining the maximum distortion energy using center of gravity G-loads acceleration cycles.

6. The method of claim 1 wherein determining the maximum distortion energy comprises determining the maximum distortion energy using center of gravity G-loads using accelerations in X, Y and Z directions.

7. The method of claim 1 wherein determining the maximum distortion energy comprises determining the maximum distortion energy using center of gravity G-loads using acceleration magnitude.

8. The method of claim 1 wherein determining the maximum distortion energy comprises determining the maximum distortion energy for the component formed of fiber reinforced polypropylene.

9. The method of claim 1 wherein determining the maximum distortion energy comprises determining the maximum distortion energy for a battery tray.

10. The method of claim 1 wherein performing the strength evaluation comprises determining the strength evaluation based on the strength threshold of 3/4 of a composite material tensile strength.

11. The method of claim 1 wherein performing the strength evaluation comprises determining the strength evaluation based on the strength threshold of ¾ of a composite material tensile strength near room temperature.

12. The method of claim 1 wherein performing the strength evaluation comprises determining the strength evaluation based on the strength threshold of 3/4 of a composite material tensile strength at 23 degrees C.

13. The method of claim 1 wherein performing the fatigue evaluation comprises determining the fatigue evaluation based on the fatigue threshold of ½ of a composite material tensile strength at 80 degrees C.

14. The method of claim 1 wherein performing the fatigue evaluation comprises determining the fatigue evaluation based on the fatigue threshold of ⅓ of a composite material tensile strength at about room temperature.

15. The method of claim 1 wherein performing the fatigue evaluation comprises determining the fatigue evaluation based on the lower of the fatigue threshold of ½ of a composite material tensile strength at 80 degrees C. or the fatigue threshold of ⅓ of the composite material tensile strength at about room temperature.

16. The method of claim 1 further comprising determining bolt joint slippage and generating the report based on bolt slippage.

17. The method of claim 1 further comprising determining a resonance frequency of the component and generating the report based on resonance frequency.

18. A system comprising:
a processor; and
a non-transitory computer-readable medium including machine readable instructions that are executable by the processor, wherein the machine readable instructions include:
determine a maximum distortion energy for a component formed of a fiber reinforced material;
perform a strength evaluation by comparing the maximum distortion energy to a strength threshold;
determine a fatigue evaluation by comparing the maximum distortion energy to a fatigue threshold; and
generate a report comprising the strength evaluation.

19. The system of claim 18 wherein the instructions further include determine bolt joint slippage and generate the report based on bolt slippage.

20. The system of claim 18 wherein the instructions further include determine a resonance frequency of the component and generate the report based on resonance frequency.
